(19) United States
(12) Patent Application Publication
(10) Pub. No.: US 2022/0034258 A1
(43) Pub. Date: Feb. 3, 2022

(54) SYSTEM AND PROCESS FOR PRODUCING CLEAN ENERGY FROM HYDROCARBON RESERVOIRS

(71) Applicant: Trindade Reservoir Services Inc., Calgary (CA)

(72) Inventor: Michael John Lundin AIKMAN, Calgary (CA)

(21) Appl. No.: 17/390,242

(22) Filed: Jul. 30, 2021

Related U.S. Application Data
(60) Provisional application No. 63/059,605, filed on Jul. 31, 2020.
(60) Provisional application No. 63/118,511, filed on Nov. 25, 2020.

(30) Foreign Application Priority Data
Jul. 31, 2020 (CA) 3088665
Nov. 25, 2020 (CA) 3100593

(51) Int. Cl. F02C 3/36; F02C 6/00

(52) U.S. Cl. CPC F02C 3/36; F05D 2220/76; F05D 2220/31; F02C 6/00

(57) ABSTRACT

In one aspect of the present disclosure, a process for producing dean energy from oil bearing reservoirs comprises the steps of: utilizing in-situ combustion to combust oil within an oil-bearing formation so as to generate thermal energy; producing the generated thermal energy to a surface using a purpose-built closed loop well system, the closed loop well system comprising a plurality of horizontal lateral circulation wells to circulate a working fluid between the ground-level surface and the subterranean oil-bearing formation so as to capture the generated thermal energy in the oil-bearing formation and transfer the captured generated thermal energy to the surface; and producing a plurality of combustion products to the surface using a plurality of production wells. A system for operating the process of producing clean energy from oil bearing reservoirs is also provided.

### CROSS REFERENCE TO RELATED APPLICATIONS

This application claims the benefit of U.S. Provisional patent application No. 63/059,605 and Canadian patent application no. 3,088,665 both of which were filed on Jul. 31, 2020 and are entitled “Process for Producing Clean Energy from Hydrocarbon Reservoirs”, and also claims the benefit of U.S. Provisional patent application No. 63/118,511 and Canadian patent application no. 3,100,593, both of which were filed on Nov. 25, 2020 and are entitled: “Closed-loop Multilateral Thermal Capture Method and System”, all of which are incorporated herein by reference.

### FIELD

The present disclosure pertains to the generation of electricity from subsurface hydrocarbon resources.

### BACKGROUND

Hydrocarbon-bearing subsurface formations are an abundant source of energy. These subsurface hydrocarbon-bearing formations are referred to as oil reservoirs when the primary hydrocarbon fluid is oil. This oil can vary from very light oils (characterized as having very low in-situ viscosity and very high API gravity, a measure of the fluid density) to very heavy oils (characterized as having very high in-situ viscosity and very low API gravity). Oil reservoirs typically are developed first by using oil production wells to bring the oil to surface but very often, soon after production begins injection of water or a gas or even steam will be used to increase the oil production rate and the total oil recovery. This injection phase is typically referred to as secondary recovery. If the economics are favorable, a tertiary phase could begin in which chemicals or a miscible gas are introduced into the injection wells to further increase the total recovery of oil.

For light oils the total recovery factor (defined as total recovery of oil divided by the original oil in the reservoir) will be much higher than the total recovery factor for very heavy oils. For very heavy oils, the remaining oil in the reservoir at the end of commercial development will vary, but values from 75% to greater than 90% of the original oil in the reservoir are typical. This is a tremendous source of energy that remains in the ground.

Once the oil is produced it is necessary to refine the crude oil to finished products, which can include fuels for transportation, refined oils for lubrication, and other petrochemical products.

Associated with the refinery operations and the end use of transportation fuels is the release of substantial amounts of carbon dioxide, a greenhouse gas. Efforts are underway to shift transportation vehicles away from internal combustion engines to electric vehicles that use batteries, or fuel cells. This allows the vehicles to be zero emitters of carbon dioxide. However, the generation of this electricity, if using conventional fossil fuels in the electrical generation power station, will produce carbon dioxide. The current outlook for the power generation sector is to capture the carbon dioxide and either store it in a deep underground geologic formation or to use the carbon dioxide as a building block for materials such as cement.

Current developments in electrical generation include the use of large wind turbine farms and solar photovoltaic farms, but these typically have low electrical output per capital dollar spent and are intermittent due to wind speed not being constant and the sun not shining 24 hours per day 355 days per year. The amount of electricity delivered to the grid over a period of time divided by the name plate potential, or 100% availability, is commonly referred to as the Capacity Factor. Typical Capacity Factors in the southern part of the province of Alberta, Canada are 15% for solar photovoltaic and 30% for wind turbines. There are other concerns being recognized regarding the adverse environmental practices in mining and refining the based materials for these industries, the relatively short life cycle for each piece of equipment (20-25 years), the high cost of abandonment (15-20% of the original capital cost) and the disturbance to the ecosystem, such as bird and bat mortality from wind turbines and the reduced growth potential of native plant life (resulting in changes to the ecosystem that such plants support) due to the shadow from solar panels, whether on land or floating on the water.

In a prior art of which the applicant is aware, an article entitled “Geothermal Power Production from Abandoned Oil Reservoirs Using In Situ Combustion Technology” by Yuhao Zhu et al (Energies 2019, 12, 4476, published Nov. 24, 2019), (hereinafter, the “Zhu Paper”) discusses the feasibility of geothermal energy recovery based on a deep borehole heat exchanger, modified from abandoned oil reservoirs using in situ combustion technology, is investigated. The Zhu Paper proposes to retrofit an abandoned oil well so that it becomes a deep borehole heat exchanger, the heat exchanger having a concentric tube design, wherein a working fluid is injected into an outer, annular cavity within the vertical well and produced through a central cavity or tube running through the vertical well. The heat energy in the produced working fluid is then used for geothermal power generation. The authors of the Zhu Paper point out an advantage of using abandoned oil reservoirs is that there is little or no drilling cost. An earlier paper entitled “Modeling of Geothermal Power Generation from Abandoned Oil Wells Using In-Situ Combustion Technology” by Xiaoming Tian et al (43^{rd} Workshop on Geothermal Reservoir Engineering, Stanford University, California, Feb. 12-14, 2018, SGP-TR-13) proposes a similar model for geothermal energy recovery based on a deep borehole heat exchanger, modified from abandoned oil reservoirs using in situ combustion technology and a retrofitted abandoned oil well that becomes a deep borehole heat exchanger having a concentric tube design.

In other prior art, of which the applicant is aware, the company Eavor Technologies Inc. designed a closed loop circulation well system for circulating a working fluid through a geothermal reservoir. Heat from deep inside the earth is thereby harvested for geothermal power generation. The closed loop circulation well system includes a plurality of lateral legs branching out from a vertical well section. A typical commercial system deployed in a region without volcanic or tectonic activity would include two vertical riser wells drilled to a depth of up to 5 km, spaced apart from one another by a horizontal distance of approximately 5 km to 10 km. The lateral wells are then drilled horizontally from the first and second vertical riser wells, the lateral wells drilled towards one another so as to join in the middle. Such multilateral well designs, drilled at such depths in order to locate the multilateral wells in a geothermal formation with sufficient heat for power generation, are difficult and risky to accomplish, due to several technical challenges that include (but are not limited to) drilling target uncertainty at such depths and the lack of reliable electronic equipment to directionally steer the wells at such high temperatures.

### SUMMARY

The present disclosure seeks to utilize deposits of medium, heavy and extra heavy oils as a source of energy to generate electricity in a process that centralizes the surface operations, allowing for the capture and disposal of the carbon dioxide gas.

In accordance with the present disclosure, air, or oxygen enriched air (hereafter referred to interchangeably as “oxygen-rich injectant”, “oxygen-rich air” or simply “air”), is injected into an oil bearing reservoir, often following a short pre-heat period. The injected oxygen will react with the oil in the heated reservoir, and these combustion reactions will generate an enormous amount of heat in the reservoir. The heat is then extracted using closed-loop horizontal wells that will circulate water (similar to a radiator) without the exchange of physical mass between the circulation wells and the formation. Only thermal energy, enthalpy, will transfer across the wall of the closed loop horizontal wells from the reservoir into the circulating fluid. To optimize the extraction of enthalpy, a system of injection and production wells are required, and the placement of all the wells is part of the overall design optimization. When the combustion process is operating according to combustion reactions known as “high temperature oxidation”, the temperature in the combustion zone will be extremely hot, typically well over 1500° F. (815° C.). As the process matures, the combustion zone will expand, first by rising vertically to the top of the formation, and then laterally outward to both sides, the shape and rate of expansion determined by the reservoir and oil properties as well as the operation of offset production and injection wells. As the combustion zone expands it will encounter the horizontal lateral wells that are part of the closed loop water circulation system. The temperature of the water in the laterals will increase due to conductive heat transfer across the steel wall. The temperature of the water at the downstream (production) end of the horizontal laterals will depend upon several factors, including but not limited to the temperature in the combustion zone, the surface area of the production tubing, the materials of the reservoir and the pipe, the water residence time (itself a function of the cross sectional area of the lateral and the flow rate), etcetera. The downstream end of each lateral will then connect to a common horizontal manifold well, which in turn connects to a vertical production riser to allow the heated water to flow to surface. The temperature of the water at surface will depend upon several factors, including the depth of the formation, the background geothermal gradient, the thermal conductivity of the vertical riser system (which can be reduced by use of insulated tubing), the flow rate of the water, amongst other factors.

The combustion gases are produced from the reservoir. If these combustion gases are not produced, they will accumulate in the reservoir and lead to a decrease in the reaction rate, which is a function of the partial pressure of oxygen (along with other parameters). The produced combustion gases will be a secondary source of value, both in terms of the heat contained in the produced gases, and certain components that may be found in the produced gases. These components may include (but are not limited to) hydrogen, methane, ethane and other hydrocarbon gas components, and light oil. All of these are products of the complex and numerous chemical reactions in the formation. These valuable components may be separated from the waste components such as nitrogen and carbon oxides. The nitrogen may be vented to the atmosphere, the carbon oxides may be collected for injection into a subsurface geologic formation for storage or for use in enhanced oil recovery, and the valuable gas components may be either sold for revenue or used for site fuel to reduce operating costs (and the carbon oxides produced from site fuel are also collected and injected into a geologic formation). The light oil that is produced may be sold to market, or preferably, in some embodiments, the produced light oil is re-injected back into the CEFO reservoir to be combusted and produce more heat which is recovered to generate electricity. The produced gas will also contain water vapour which when condensed and treated for impurities, may be a valuable source of water that could be used for irrigation or industrial use. The technical aspects of the light oil production and reinjection are considered next.

There may be a lag period between the start of oxygen injection and sufficient heat in the reservoir to be able to economically extract enthalpy for the generation of electricity, During this lag period, as the in situ combustion process is operated in the reservoir, additional oil will be mobilized to the production wells. Until the reservoir is sufficiently hot and there is a stable production of electricity for sales, this produced oil may be sold to generate cashflow to fund the operation. When there is stable production of electricity for sale to the electrical grid, produced from extracting enthalpy from the reservoir, the produced oil may be reinjected into the same oil reservoir, where it will be combusted to generate heat in the formation. The set point ratio of injected oil to produced oil may vary from zero to one, on average; process disruptions or surge tank operations that cause the ratio to vary from its set point will smooth out over time. However, for the operation of the clean energy from oil (“CEFO”) process, once the reservoir is sufficiently hot enough to generate electricity from the heated circulated water in the Multilateral Thermal Capture System (“MLTCS”) system and/or the fluids produced from the ventilation wells, this ratio should be closer to one than zero. When the CEFO process is mature and producing stable electricity, ideally, the ratio will be equal to or approximately equal to one, indicating complete or near-complete re-injection of all produced oil. A high ratio of injected to produced oil fulfills several purposes, including but not limited to the following:
1) allows the fuel to remain in the reservoir so that the energy in the oil is converted to heat, which may then be extracted to feed into the electrical generation process;
2) results in long-lived and stable generation of electricity, allowing for long term contracts with the electrical utility companies;
3) enables undesirable combustion products such as carbon dioxide to be captured in a centralized process, after which the carbon dioxide is re-injected into a formation for permanent disposal or storage. Advantageously, this enables the utilization of fuel contained in the oil reservoir for the generation of electricity, without the release of carbon dioxide and other greenhouse gases that occurs when the fuel is combusted for energy generation or for the operation of internal combustion vehicles; and
4) enables the use of oil resources contained in the reservoirs without the need to produce and ship the oil to other locations, such as by pipeline or train, which transportation involves the risk of accidental release of the produced oil into the environment.

In embodiments of the technology, the subsurface reservoir can be thought of as both a subterranean furnace to produce heat, and a subterranean reactor that will cause the conversion of the oil (which could range from medium to extra heavy crude oil), oxygen and water to generate heat, light oil (which is less viscous and has a higher API gravity oil than the original in place oil), and possibly hydrogen, methane, ethane and other natural gas liquids through thermal cracking reactions. In some embodiments, if there are suitable amounts of hydrogen, methane, ethane and other natural gas liquids produced, there may be economies of scale that would lead to profitable extraction and concentration of these substances for additional sales revenue (either as separate component streams or as a blend of high quality gases for combustion or petrochemicals). In some embodiments of the technology, the produced gas composition and volumetric flow rate may be high enough in combustible products to be used on site as a source of energy to drive the surface equipment used in the CEFO process, which will reduce the operating expenses and allow the carbon dioxide that is generated in surface power supply to be captured and disposed underground.

In one aspect of the present disclosure, a process for producing clean energy from oil bearing reservoirs comprises the steps of:
utilizing in-situ combustion to combust oil within an oil-bearing formation so as to generate thermal energy;
producing the generated thermal energy to a surface using a closed loop well system, the closed loop well system comprising a plurality of horizontal lateral circulation wells to circulate a working fluid between the ground-level surface and the subterranean oil-bearing formation so as to capture the generated thermal energy in the oil-bearing formation and transfer the captured generated thermal energy to the surface; and
producing a plurality of combustion products to the surface using a plurality of production wells.

In some embodiments, the generated thermal energy captured in the working fluid is flashed at surface to a lower pressure, thereby converting the working fluid from a liquid-phase to a high pressure vapour-phase. The high pressure vapour-phase then flows through a steam turbine system to generate electricity. The working fluid downstream of the electrical turbines will still contain substantial thermal energy. This residual thermal energy may be utilized for a heating application, such as district heating or greenhouse agriculture, before it is reinjected into the MLTCS system to capture more heat from the reservoir.

The plurality of combustion products includes gaseous combustion products, and the generated thermal energy captured in the gaseous production products may be transferred to a secondary working fluid so as to generate a secondary high pressure vapour-phase. In such embodiments, the secondary high pressure vapour-phase then flows through the steam turbine system to generate electricity. In one aspect of the disclosure, the working fluid and/or the secondary working fluid each have a boiling point equal to or lower than water.

In another aspect of the present disclosure, each horizontal lateral circulation well of the plurality of horizontal lateral circulation wells is substantially parallel to one another. The plurality of horizontal lateral circulation wells may be in fluid communication with one another through at least one horizontal manifold well, the horizontal manifold well intersecting the plurality of horizontal lateral wells. The plurality of horizontal lateral circulation wells may include two or more sets of horizontal lateral circulation wells, wherein the two or more sets of horizontal lateral circulation wells are positioned laterally of and substantially parallel to at least one horizontal air injection well. The at least one horizontal air injection well is preferably positioned at an air injection depth in the oil-bearing formation and each set of the two or more sets of horizontal lateral circulation wells are positioned at a circulation well depth in the oil-bearing formation, wherein the air injection depth from ground level (or surface) exceeds the circulation well depth from ground level (or surface).

The plurality of combustion products includes valuable by-product gases and waste by-product gases. In some embodiments of the process, the valuable by-product gases are recovered and separated at the surface, while the waste by-product gases are separated and injected into a second oil-bearing formation for permanent storage. The waste by-product gases include, for example, carbon dioxide. In some embodiments, a volume of produced valuable by-product gases is under a selected threshold, in which case the process further includes the step of injecting the valuable by-product gases into a second geologic formation for temporary storage. In some embodiments, the valuable by-product gases are selected from a group comprising: hydrogen, methane, liquified petroleum gases, condensate, oil. The valuable by-product gases that are produced to the surface may also used as a supplemental source of energy to power on-site systems, and/or the valuable by-product gases recovered at the surface may be re-injected into the oil-bearing formation as an input into the in-situ combustion so as to generate the thermal energy within the oil-bearing formation.

In other embodiments, the waste by-product gases include CO₂, and the step of injecting the waste by-product gases into a second oil-bearing formation may include where the CO₂ improves oil recovery from the second oil-bearing formation and permanently stores the said CO₂ in the second oil-bearing formation by a process selected from the group comprising: CO₂ miscible enhanced oil recovery process, CO₂ immiscible enhanced oil recovery process.

In some embodiments, the valuable by-product gases are re-injected into the oil-bearing formation as an input to the in-situ combustion for generating thermal energy in the oil-bearing formation, and the waste by-product gases are injected into a second geologic or oil-bearing formation for permanent storage, so as to release a net volume of zero by-product gases into an atmosphere.

In another aspect of the disclosure, the process includes a step of pre-heating the oil-bearing formation to a temperature threshold that enables auto-ignition of the oil when oxygen is injected into the oil-bearing formation, so as to form a combustion chamber in the oil-bearing formation. The process may further include the step of recovering a portion of oil from the oil-bearing formation. When the combustion chamber has reached a selected temperature, the portion of oil recovered from the oil-bearing formation is re-injected into the oil-bearing formation as an input into the in-situ combustion so as to generate the thermal energy within the oil-bearing formation.

In some embodiments, the process may include the steps of applying the electricity generated from the steam turbine system to an electrolysis plant so as to generate hydrogen and oxygen from water; shipping the generated hydrogen for off-site energy use; and adding the generated oxygen to an injection stream of the in-situ combustion so as to generate thermal energy in the oil-bearing formation. In other embodiments, the electricity generated from the steam turbine system is transferred to an electrical grid.

When the process reaches a late maturity stage, the step of utilizing in-situ combustion is halted and the generated thermal energy that is stored in the rocks of the oil reservoir may continue to be produced to the surface using the closed loop well system during a wind-down period, so as to increase the overall thermal efficiency of the process.

In another aspect of the disclosure, the step of utilizing in-situ combustion is cyclically controlled so as to maintain an amount of generated thermal energy in the oil reservoir within a targeted range and control oxygen production at the ventilation production wells. The oil reservoir may be selected from a group comprising: medium oil reservoir, heavy oil reservoir, bitumen oil reservoir.

In still another aspect of the present disclosure, a system for producing clean energy from oil bearing reservoirs comprises:
an air injection well for injecting oxygen-enriched air into an oil reservoir for in-situ combustion of oil contained therein so as to generate thermal energy;
a closed loop well system comprising at least two sets of a plurality of horizontal lateral circulation wells to circulate a working fluid between the oil reservoir and a surface above the oil reservoir so as to capture the generated thermal energy and transfer the captured generated thermal energy to the surface;
a production ventilation well for producing combustion by-products of the in-situ combustion to the surface; and
a steam turbine system driven by the heat from the circulating working fluid and the fluid from the ventilation production wells so as to generate electricity.

The system may further include an oil injection well, wherein oil produced through the production ventilation well is re-injected into the oil reservoir as an input to the in-situ combustion. The system may also include a secondary heat exchanger containing a secondary working fluid, the secondary heat exchanger in thermal communication with the production ventilation well so as to capture thermal energy from the combustion by-products produced through the production ventilation well. The secondary working fluid may be used as an input to the steam turbine system.

In some embodiments, the system includes an electrolysis plant, the electrolysis plant driven by the electricity generated by the steam turbine system, wherein the electrolysis plant electrolyzes water so as to generate hydrogen and oxygen. The generated hydrogen is shipped off site for energy use, and the generated oxygen is used as an input to the in-situ combustion of the oil in the oil-bearing formation so as to generate the thermal energy.

### BRIEF DESCRIPTION OF THE DRAWINGS

In the accompanying drawings, which illustrate exemplary embodiments of the present disclosure:

FIGS. 1A and 1B are simplified plan and section views (respectively) of an illustrative example of the early stage of the CEFO process.

FIG. 1C is a different plan view of the CEFO process illustrated in FIGS. 1A and 1B at the same point in time, wherein the field of view of the CEFO process has shifted so that the central feature is the air injection well.

FIGS. 2A and 2B are simplified plan and section views (respectively) of the mature stage of the CEFO process shown in FIGS. 1A to 1C.

FIGS. 3A and 3B are simplified plan and section views (respectively) of the late mature stage of the CEFO process shown in FIGS. 1A to 1C.

FIGS. 4A and 4B are simplified plan and section views (respectively) of the formation at the start of the wind down stage of the CEFO process shown in FIGS. 1A to 1C.

FIG. 5 is a section view of a formation to show, qualitatively, the vertical and lateral placement of wells relative to the vertical depth in the formation and the placement of other wells in the CEFO process.

FIGS. 6A and 6B are simplified three-dimensional and plan views (respectively) of an embodiment of the closed-loop Multilateral Thermal Capture System (“MLTCS”).

FIGS. 7A and 7B are simplified three-dimensional and plan views (respectively) of another embodiment of the dosed-loop MLTCS.

FIGS. 8A and 8B are simplified three-dimensional and plan views (respectively) of another embodiment of the closed-loop MLTCS.

FIGS. 9A and 9B are simplified three-dimensional and plan views (respectively) of a further embodiment of the closed-loop MLTCS.

FIG. 10A is a three-dimensional graphical view of the temperature of a simulation of an oil reservoir after 2,000 days of the CEFO process in operation, showing the full reservoir temperature distribution and the layout of the various wells.

FIG. 10B is a three-dimensional graphical view of the temperature of the simulation of an oil reservoir of FIG. 10A, after 2,000 days of the CEFO process in operation, with the isothermal temperature contour where the reservoir temperature is 400° F.

FIG. 10C a three-dimensional graphical view of the temperature of the simulation of an oil reservoir of FIG. 10A, after 2,000 days of the CEFO process in operation, illustrating slices through the reservoir taken every 500 feet in a direction normal to the multilateral wells; the illustrated slices are at rows 5, 15, 25, 35 and 45; each of these slices is 50 feet in thickness.

FIGS. 11A through 11E are two-dimensional graphical views of the slices through the reservoir of FIG. 10C, taken at rows 5,15, 25, 35 and 45 respectively.

FIG. 12 is a line graph illustrating the surface temperature of the water, in degrees Celsius, of the closed loop MLTCS system at the production well head, as obtained from the simulation illustrated in FIGS. 10A-11E.

FIG. 13 is a line graph illustrating the flow rate of the water, in barrels of water per day, in the closed loop MLTCS system, as obtained from the simulation illustrated in FIGS. 10A-11E.

FIG. 14 is a line graph illustrating the enthalpy production rate, in giga Joules per day, in the closed loop MLTCS system, as obtained from the simulation illustrated in FIGS. 10A-11E.

Exemplary embodiments of the present disclosure will now be described with reference to the accompanying drawings.

### DETAILED DESCRIPTION

Throughout the following description, specific details are set forth in order to provide a more thorough understanding to persons skilled in the art. However, well known elements may not have been shown or described in detail to avoid unnecessarily obscuring the disclosure. The following description of examples of the disclosure is not intended to be exhaustive or to limit the disclosure to the precise form of any exemplary embodiment. Accordingly, the description and drawings are to be regarded in an illustrative, rather than a restrictive, sense.

Throughout this specification, numerous terms and expressions are used in accordance with their ordinary meanings. Provided below are definitions of some additional terms and expressions that are used in the description that follows.

“Oil” is a naturally occurring, unrefined petroleum product composed of hydrocarbon components. “Bitumen”, “heavy oil”, “medium oil” and “light oil” are normally distinguished from other petroleum products based on their densities and viscosities at 25° C. and atmospheric pressure (101.325 kPaa). “Light oil” is typically classified with a density which is less than 870 kg/m3. “Medium oil” is typically classified with a density which is between 870 kg/m3 and 920 kg/m3. “Heavy oil” is typically classified with density of which is between 920 and 1000 kg/m3. “Bitumen” typically has density greater than 1000 kg/m3. For purposes of this specification, the terms “oil”, “bitumen” and “heavy oil” are used interchangeably such that each one includes the other. For example, where the term “bitumen” is used alone, it includes within its scope “heavy oil”. Where the term “Oil” is used alone, it includes in its scope “medium oil” and “heavy oil” and “bitumen”.

As used herein, the terms “petroleum reservoir” and “oil reservoir” are used interchangeably throughout this specification to refer to a subsurface formation that is primarily composed of a porous matrix which contains petroleum products, namely oil and gas. As used herein, “medium oil reservoir” refers to a petroleum reservoir that is primarily composed of porous rock containing medium oil. As used herein, “heavy oil reservoir” refers to a petroleum reservoir that is primarily composed of porous rock containing heavy oil. As used herein, “oil sands reservoir” refers to a petroleum reservoir that is primarily composed of porous rock containing bitumen.

“Cracking” refers to the thermally induced splitting of larger hydrocarbon chains into smaller-chained compounds. The term “in situ” refers to the any activity that occurs in the petroleum reservoir. For example, “in situ chemical reaction of oil” refers to chemical reactions of the oil that occur in the petroleum reservoir and not on surface after the oil has been recovered from the petroleum reservoir.

“Oxygen-rich injectant”, “oxygen-rich air” or “air” are all used interchangeably throughout this specification to indicate the injection of oxygen into the formation which is carried in another inert gas such as nitrogen. For example, common air is roughly 21% oxygen and 79% nitrogen (with other amounts of trace gases). The amount of oxygen can be increased in air by oxygen enrichment processes.

In broad aspects, the exemplary methods and systems described herein use the petroleum reservoir first and foremost as an energy source, in which the energy found in the oil is extracted to surface. All design features of CEFO are made for the specific purpose of maximizing the recovery of thermal energy from the oil reservoir. In contrast, other descriptions of enthalpy extraction from oil reservoirs, such as found in the Zhu Paper and the Tian Paper discussed in the background section above, is an afterthought or secondary consideration, which impacts the design of the well construction and placement. As a consequence, the amount of energy that is potentially harvested from the oil reservoir in such prior art systems is lower than the amount of energy that is potentially harvested from the oil reservoir when using the CEFO systems and processes described herein.

Selection of Suitable Reservoirs for the CEFO Process

In a preferred embodiment, the oil bearing formations that are best suited for the CEFO process contain medium to heavy oil (API gravity less than approximately 30° API), are relatively shallow in depth (less than approximately 2500 m from ground level surface), are relatively thick (greater than approximately 10 m from cap rock to base rock), have high permeability (greater than approximately 500 mD horizontal and vertical permeability), and are relatively free of impermeable shale barriers. Some amount of shales may be tolerated, so long as these do not have extensive lateral or areal continuity. The amount of oil that remains at the start of the CEFO process should be on the order of at least 60% of the original oil in place. Ideally, some amount of waterflood operation has been conducted so as to characterize the structure and connectivity of the reservoir. Legacy wells could be reused for the CEFO process if the original well construction and materials (for example, the type of steel used for the well casing and the type of cement used for the completion operation) as well as mechanical inspections of the current state of the well determine that the well is in good shape. However, given the long life of the CEFO operation, and the relatively low cost for drilling and completing new wells at shallow formation depths, it may be preferable to redrill all wells used in the CEFO operation to minimize the risk of future well failure. This is a key distinction between the CEFO process and other prior art that might appear similar: for a CEFO process and system, all wells are designed and the project is operated for the specific purpose of maximizing thermal extraction, which leads to higher recovery of the energy found in the oil. This is in contrast other processes where the production of oil is the primary objective and the recovery of heat energy, using that existing well system for the production of oil, is a secondary objective.

Well Types and Positioning by Depth in the Formation

In general, the present specification describes systems and methods to treat oil reservoirs (light oil, medium oil, heavy oil, oil sands reservoirs, carbonate oil reservoirs) to recover energy found in the oil. The methods include injection of oxygen or an oxygen-rich stream into the reservoir to combust the hydrocarbons in the reservoir releasing the energy contained therein as heat. This heat is then recovered to surface and used to drive electrical generating turbines to produce electricity, which is then dispatched to the electrical utility grid.

In some preferred exemplar embodiments, the oxygen-rich stream is injected into the formation using horizontal wells placed at the bottom of the formation, or as low in the formation as practical. In other embodiments, the oxygen-rich stream can be injected into the formation using vertical or deviated wells if the perforations of the wells are only toward the lower part of the formation, the injection wells are situated along a single line and the distance between these injection wells is small, preferably less than 100 feet apart. This will allow a “wall of combustion” to be formed that, in late stages of the process, will mimic the effect of a single horizontal well.

In some preferred embodiments, the ventilation production wells are horizontal wells placed at the top of the formation, or as high in the formation as practical. In other embodiments, the ventilation production wells can be vertical or deviated wells if the perforations of the wells are only toward the upper part of the formation, the ventilation wells are situated along a single line and the distance between these ventilation wells is small, preferably less than 100 feet apart. This will allow a “wall of production” to be formed that in late stages of the process that will mimic the effect of a single horizontal well.

In some preferred embodiments, the re-injection of produced oil back into the formation for combustion is accomplished using horizontal wells placed at the bottom of the formation or as low in the formation as practical. In other embodiments, the re-injection of produced oil back into the formation for combustion can be accomplished using vertical or deviated wells if the perforations of the wells are only toward the lower part of the formation, the oil re-injection wells are situated along a single line and the distance between these injection wells is small, preferably less than 100 feet apart. This will allow a “wall of oil re-injection” to be formed that in late stages of the process will mimic the effect of a single horizontal well. The air injection well is placed low in structure so that the oil will flow down under gravity at the interface between the gaseous combustion chamber and the oil banks and combust with the injected air. The oil reinjection wells are also placed low in structure so that the oil will not simply re-circulate between the ventilation wells and the oil injection wells.

In all embodiments, the water circulation system uses horizontal lateral wells that are substantially parallel to each other and substantially parallel to the oxygen injection horizontal wells (or oxygen injection vertical line wells), and located at as high in structure as practical. Such water circulation systems, comprising a plurality of horizontal lateral wells, would be designed and drilled for the particular abandoned or commercial end-of-life oil reservoir, and would not be created by re-purposing any pre-existing wells. The Figures outline a particular example that uses two sets of five lateral wells for the closed-loop water circulation system, and these two sets of lateral wells are placed on either side of the plane of the combustion front resulting from oxygen injection. The use of five wells in each set is not restrictive. The exact number of wells in each set would be determined from detailed engineering and economic evaluations on each unique reservoir. In various cases that have been investigated, this has ranged from two up to seven laterals in each set, but the number of lateral wells may be eight, nine, ten or more laterals per set.

Advantageously, by using multiple horizontal lateral wells in a dosed loop well circulation system, for circulating water or another working fluid through the heated formation, the efficiency of heat transfer to the surface is improved by increasing the surface area of horizontal lateral wells that come into contact with the heated formation. In contrast, the closed loop well circulation system, such as described in the Zhu Paper, is inefficient because the surface area for heat transfer in the heated reservoir is small, the retention time of the water in the hot reservoir zone is also small due to the use of many concentric tubing strings in the same well, leading to a very small cross-sectional area for flow, and there is a counter-current heat exchange that essentially transfers heat from the hot water that is rising in the inner annular space to the cold water that is flowing downward in the outer annular space. It is noted in the Zhu paper that after 15 years of operation, the maximum well head temperature is only 150° C. In contrast, the CEFO process is capable of maximum well head temperatures approaching 300° C., due to the very high surface area for heat transfer, the very high retention time for circulating water in the heated reservoir section, and the use of dedicated riser pipe for production of hot water which can easily accommodate an insulated tubing string to minimize heat loss to the overburden. Wellhead temperatures for CEFO may approach 300° C. within several years of the start of operation and remain well above 200° C. for several decades, a distinct advantage over other known designs that aim to harvest energy from oil or deep geologic formations. The overall design of CEFO, including new designs for wells and how these are constructed, placed in the formation, distinguish the CEFO systems and processes from the known prior art designs and result in a more efficient process for harvesting energy from oil.

There are variations in how the horizontal lateral wells are connected to the surface as outlined in FIGS. 6A through 9B. In each of the systems illustrated in FIGS. 6A-9B, no water is injected into the formation and no fluid is produced from the formation. These systems, as demonstrated in the illustrated exemplary embodiments, are analogous to a radiator in which the fluid circulates through the radiator coils to heat a room without releasing hot water into the room. This is in contrast to the possibility of harvesting residual heat from an end-of-life steam-assisted gravity drainage (“SAGD”) operation, which would involve injecting water directly into the formation and then producing that water directly out of the formation, which produced water would be contaminated with hydrocarbons from the formation. The harvesting of residual heat from an end-of-life SAGD operation will only last one to two years. It is not possible to implement earlier heat harvesting from a SAGD operation, since this would shut down the oil production which in the primary purpose of SAGD. Heat extraction is an afterthought for late-life SAGD heat harvesting. In contrast, heat extraction is the primary and overarching purpose of the CEFO systems and processes and every part of CEFO has been designed to maximize the extraction of the heat resource.

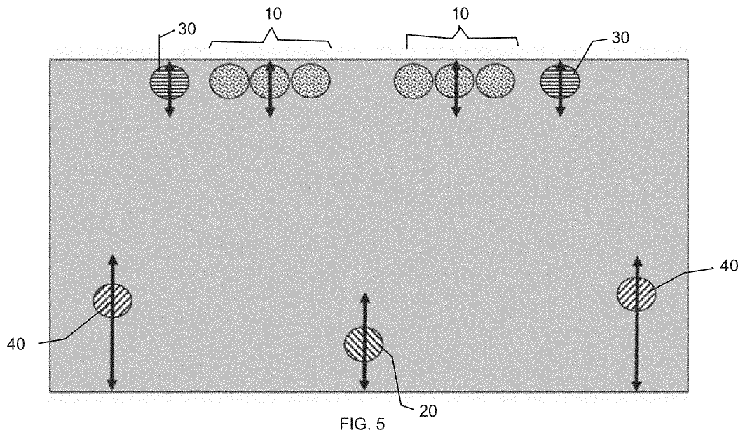

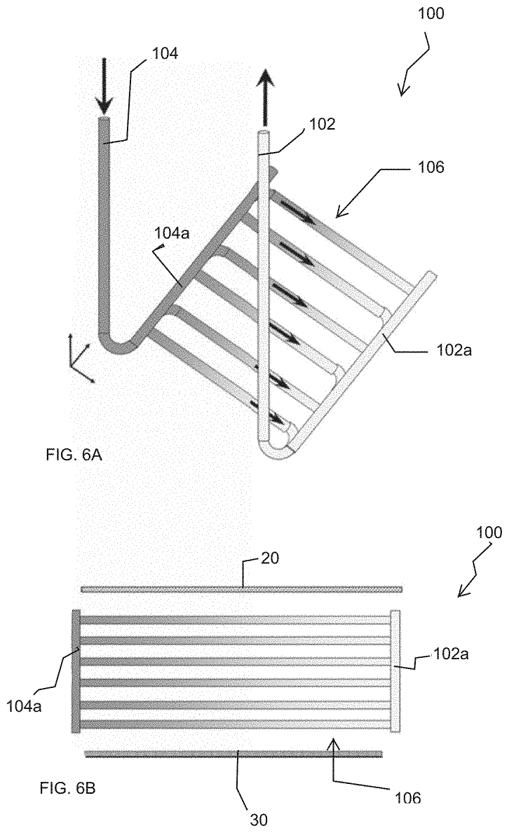

FIG. 5 is a qualitative depiction of the preferred relative location of the wells in the CEFO process, both in terms of the vertical placement in the formation as well as the lateral placement of wells with respect to other well types. The exact placement of wells, vertically and laterally, will be determined by detailed engineering design and modeling for each unique reservoir system and these exact parameters are not generic and cannot be stated before the design and modeling process has been completed.

Well Operations

In some embodiments, the operation of the CEFO process is continuous, excepting short-duration shut downs as may be required by prudent maintenance operations or certain data acquisition operations. The oxygen-rich injectant is continuously injected into the formation and, after the short term start up operations, the injection pressure and injection rate are reasonably constant over time. The ventilation production system is also operated continuously at a pre-set production pressure and production rate. The oil re-injection system is operated continuously after the formation has heated up, and after the reservoir temperature has heated up and hot water is being extracted from the formation by the water circulation system to produce electricity, most or all of the produced oil is re-injected back into the formation for combustion. The water circulation system is operated continuously and always with water circulating through the horizontal lateral circulation wells at a rate sufficient to ensure that the lateral wells do not overheat (as a person skilled in the art would determine, based on the property of the materials used in constructing the wells).

In other embodiments, certain wells may be operated cyclically, or intermittently. The cyclically or intermittently operated wells may include the oxygen-rich injection wells, the ventilation production wells, and the oil re-injection wells. The periodic suspension of operation of the well, and its subsequent reactivation, would be determined by the nature of the formation, the oil and the performance of the CEFO process, as would be known to a person skilled in the art. For example, it may be preferential to operate cyclical air injection to allow the injected oxygen-rich stream to have a longer residence time in the formation and to allow for more complete combustion and generation of heat from the combustion process. Similarly, there may be situations in which the oil re-injection process may be operated cyclically, in particular if the produced oil volume is so low that prudent operational constraints indicate that it is more preferential to re-inject the oil in batches. However, in all embodiments of the system and process, the water circulation system is operated continuously. In some embodiments, specific formations or configurations of the system may enable an adjustable flow rate for the water circulation system, so as to allow for a more constant temperature of the produced water. In other embodiments, the water flow rate is more or less constant and the temperature of the produced water is allowed to vary, but within safe operating constraints as determined by a person skilled in the art, based on the material and process constraints.

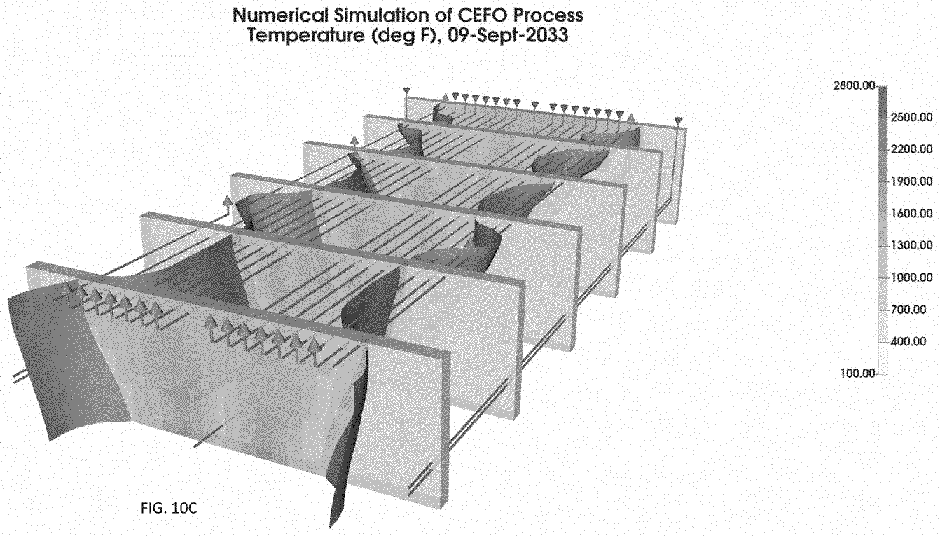

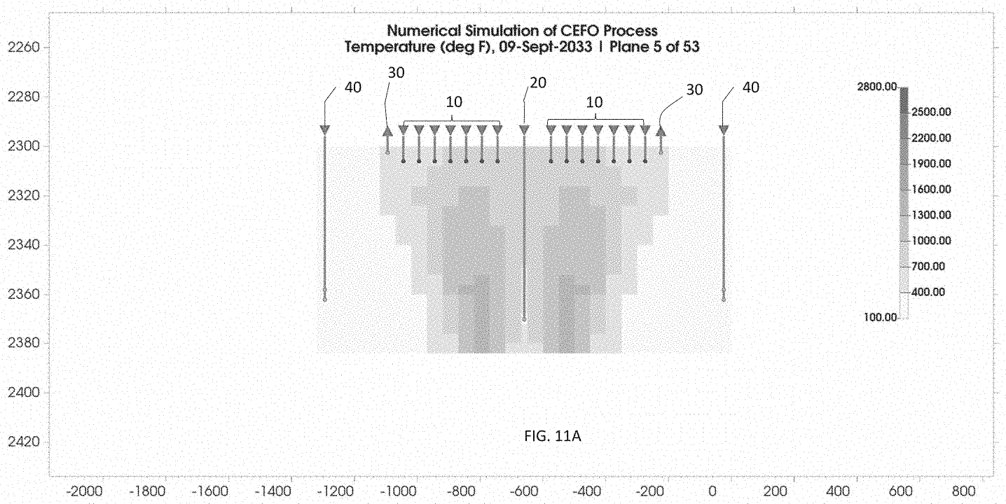

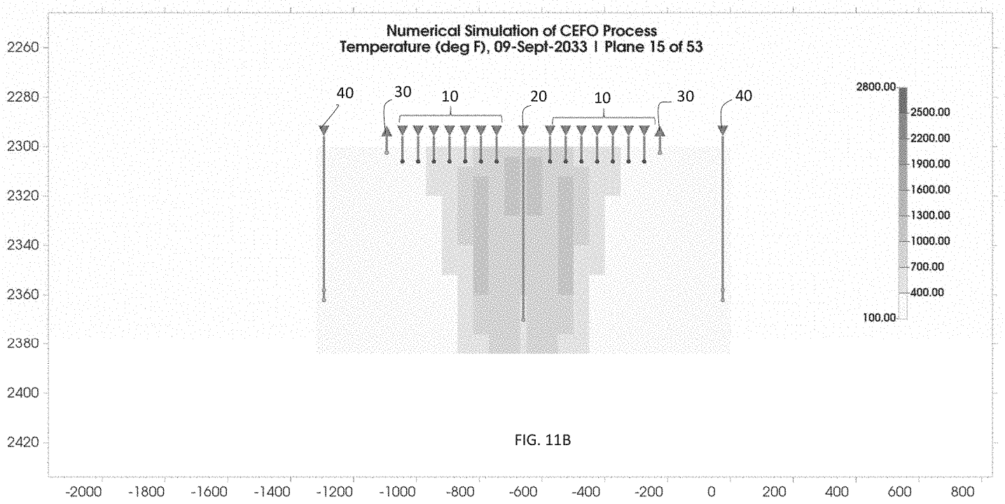

The following section outlines the sequence of events for the use of CEFO to extract energy from a typical heavy oil reservoir, with reference to a simulated model described and illustrated in FIGS. 10A to 14, which simulation is used as an illustrative example of how the process may work. Many features in the standard development of a hydrocarbon reservoir are not described in full, as these are well known to practitioners skilled in the art of the development of hydrocarbon reservoirs. Nor is the following intended to be a restrictive description. There are many possible variations on the development path that would be defined as a result of detailed engineering and technical evaluations on each specific reservoir according to the unique properties and response predictions of each specific reservoir.

Sequence of Operations for a Typical Heavy Oil Reservoir

Start-Up and Vertical Migration of the Combustion Chamber—Early Stage

Following the placement of the wells necessary for CEFO (including the oxygen injection wells, the water or working fluid circulation wells, the ventilation production wells and the oil re-injection wells), a first step in some embodiments of the CEFO process is to introduce heat into the reservoir during a pre-heating period. While there are some oils that will spontaneously combust in the presence of oxygen, the autoignition time could possibly be months or even years. By pre-heating the reservoir, the time to the start of combustion (once oxygen is introduced) is greatly reduced, and the probability that the reaction mechanisms will immediately proceed primarily by High Temperature Combustion reactions (instead of Low Temperature Oxidation reactions) is increased. This pre-heating could be accomplished many ways as are known or will be known to a person skilled in the art. Methods include, but are not limited to, injection of high temperature steam, injection of a chemical that will react and release significant heat, use of radiofrequency to generate heat, a downhole electric heater, etcetera. This preheat period will be specific to the unique properties of a particular reservoir and could vary from days to months in duration.

Following the pre-heating period, an oxygen-rich stream is injected into the air injection well, the ventilation production wells will begin production to maintain the reservoir pressure at a stable value, and the working fluid circulation wells will be activated at a low level to both monitor for temperature changes to the circulating working fluid and to prevent thermal damage to the mechanical integrity of the circulation system. The oil re-injection wells are not active at this stage in the process. The exact concentration of oxygen in the injected air would be determined from detailed engineering and economic studies, as would be known to a person skilled in the art. As the oxygen contacts the oil in the formation at elevated temperature, the oil will start to combust and release heat and combustion products, which may include but are not limited to CO₂, CO and H₂O, amongst other products of the combustion reaction. The hot combustion gases will have a lower density and a lower viscosity than any of the liquids in the formation and will rise to the top of the formation under gravitational forces. The heat that is released will lead to some thermal cracking reactions of the oil, forming lower molecular weight hydrocarbons, such as methane and propane, and even hydrogen, amongst other lower weight components.

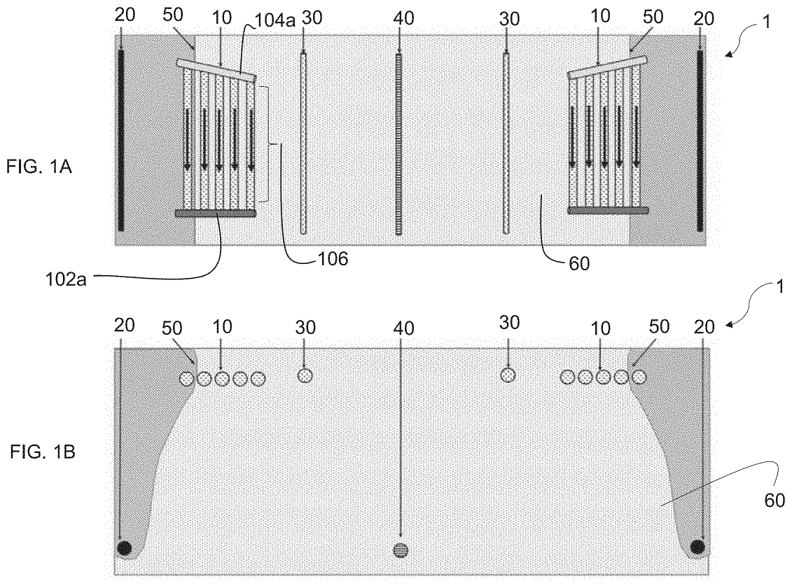

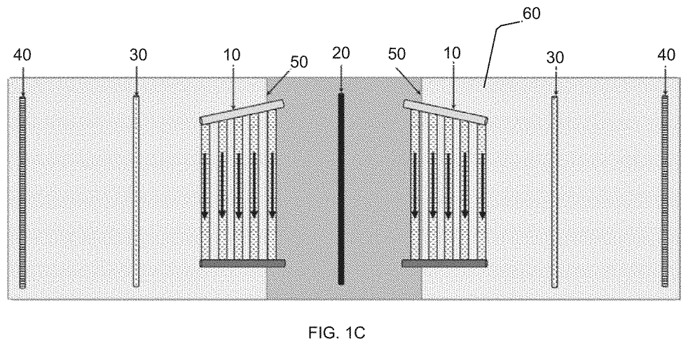

As oxygen injection continues, combustion will continue and form a combustion chamber that is defined as having a very high temperature (typically above 300° C.), and a very low oil saturation (typically less than 10% saturation), since the oil in the combustion chamber has been combusted or displaced. The combustion chamber will rise to the top of the formation where it will hit the cap rock, which is a naturally occurring impermeable seal that prevents the vertical migration of fluids. At this stage in the process, the combustion chamber will begin to spread laterally along the top of the formation, enhanced by the operation of the ventilation production wells. Once the lateral spread of the combustion chamber arrives at the first of the plurality of horizontal lateral circulation wells, the temperature of the circulated working fluid will increase. This is the early stage of the CEFO process that is depicted in FIGS. 1A, 1B and 1C.

Referring to FIGS. 1A to 1C, a portion 1 of an oil reservoir is depicted, having the wells in place for operating the CEFO process, and the CEFO process is at an early stage as described above. It will be appreciated that the portion 1 of the oil reservoir depicted in FIGS. 1A to 1C is only a representative portion of a larger oil reservoir system, and that the wells shown in FIGS. 1A to 1C would repeat in a same or similar pattern or arrangement, up to dozens or hundreds of times so as to cover the entirety of the targeted oil reservoir. For example, it will be appreciated that FIG. 1C shows an overlapping portion of the oil reservoir depicted in FIGS. 1A and 1B, such that the center of symmetry in FIG. 1C is the air injection well 20, whereas in FIGS. 1A and 1B, the center of symmetry is the oil re-injection well 40. For example, the pattern depicted in the plan view of FIG. 1A may repeat itself many times over, such that the portion of the oil reservoir shown in FIG. 1A is surrounded by similar portions 1 in each of the cardinal directions surrounding the portion 1 of FIG. 1A.

In FIGS. 1A to 1C, the combustion chamber is shown at the early stage of the process, at which point a portion of the hydrocarbons in the reservoir have been combusted and the hot combustion zone has risen to the top of the formation, as best viewed in FIG. 1B, in which it is shown that the combustion front 50 surrounds the oxygen-rich air injection horizontal well 20 and has extended vertically upwardly to the top of the formation. The system shown in FIGS. 1A to 1C also includes a pair of MLTCS 10, 10, which are used for the closed-loop circulation of water or another working fluid for harvesting the enthalpy released by the combusted hydrocarbons and producing the enthalpy to the surface. As depicted, the MLTCS 10, 10 includes five horizontal lateral wells 106 extending from an injection side manifold borehole 104a to a production side manifold borehole 102a; however, as discussed elsewhere in this disclosure, there are many different ways of constructing an MLTCS, and the present disclosure is not intended to be limited to the specific design of MLTCS depicted in FIGS. 1A to 1C. Additionally, there are two ventilation production horizontal wells 30, 30 and an oil re-injection well 40.

As viewed in FIGS. 1A and 1B, the combustion front 50 has reached the first of the plurality of horizontal lateral wells 106 at this early stage in the process, and the temperature of the water circulating through the MLTCS is beginning to increase. Additionally, there is no combustion chamber formed around the oil re-injection horizontal well 40. The oil re-injection horizontal well 40 is not yet in use at this early stage of the process.

Lateral Migration of the Combustion Chamber—Mature Stage

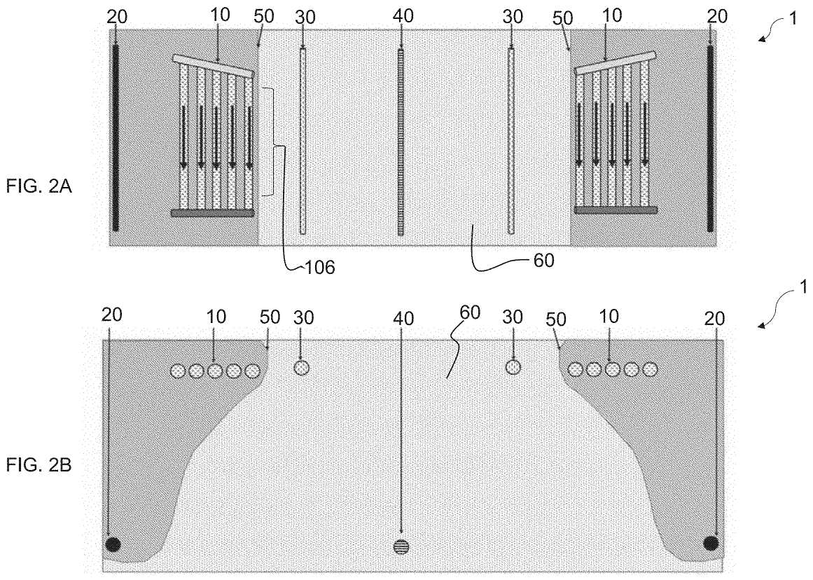

As oxygen injection and combustion continues, all wells continue to operate as described above. The combustion chamber, delineated by the combustion front 50, continues to expand laterally along the top of the formation. As the combustion chamber expands and the uncombusted zone 60, having a high oil saturation, decreases in size, more of the heat is captured by the dosed loop MLTCS system 10. At the mature stage of the process, illustrated in FIGS. 2A and 2B, it is shown for example that the combustion front 50 has expanded such that the combustion chamber now surrounds the pair of dosed loop MLTCS systems 10, 10, and as a result the closed loop MLTCS systems 10, 10 are exposed to the higher temperatures of the combustion chamber. When there is sufficient temperature and flow rate, the water from the closed loop system 10 can be used to drive an electrical steam turbine system. The electrical steam turbine system may include a plurality of electrical turbines, as the water (or other working fluid) will continue to increase in temperature as the combustion chamber continues to expand and contact additional laterals 106. In some embodiments, the generated thermal energy captured by the working fluid may be used in other heating applications, such as district heating or in greenhouse agriculture.

In some embodiments of the process, the flow rate through all lateral wells is constant and the temperature will vary. In a preferred embodiment of the technology, a series of flow control valves may be used on the MLTCS system (on the injection side, or manifold well 104A) to maintain the flow rate of the working fluid through the laterals that are not in the combustion zone at a lower rate and increase the flow rate of the working fluids through the lateral wells 106 that are situated in zones that are increasing in temperature.

At the mature stage in the process, a snapshot of time of which is depicted in FIGS. 2A and 2B, the fluid produced from the ventilation wells 30, 30 is still relatively cool, but the composition of the produced ventilation fluids should be showing indications of combustion products and thermally cracked products, such as hydrogen, methane, liquified petroleum gases (“LPG”) and lower viscosity oil. It is also possible that the produced water will have much lower salinity than the original formation brine, since one of the combustion products is water that is free of any salts.

Migration of the Combustion Chamber to the Ventilation Producer Pseudo Steady-State Operations

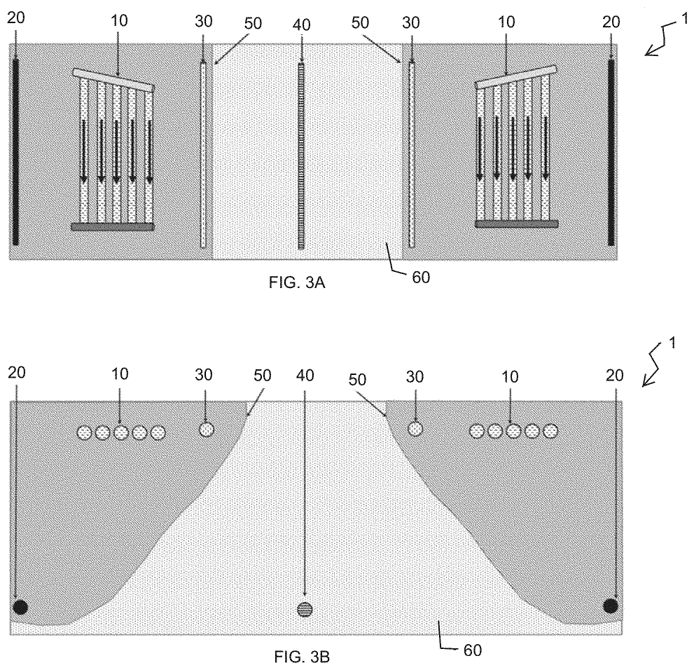

As the process continues, the combustion chamber continues to expand so as to spread laterally across the top of the formation engulfing all of the multilateral heat extraction wells 106 of the dosed loop MLTCS systems 10 and the ventilation production wells 30, as depicted in FIGS. 3A and 3B. When the combustion chamber, delineated by the combustion front 50, reaches the ventilation production wells 30, the fluids produced from these wells will increase in temperature. The temperature and flow rate of the water circulating through the multilateral well system 10 at this stage of the CEFO process will remain high with a high content of energy so that the energy contained in the circulating water is relatively stable and capable of driving steam turbines in the surface facilities to produce a relatively stable level of electricity.

Additionally, during this stage of the CEFO process the temperature of the vapour phase produced from the ventilation wells is also heated to a sufficiently high temperature such that the energy contained in the fluid produced from the ventilation wells 30 is capable of driving electrical generation turbines. The temperature of the fluids will be high enough to generate electricity, in some embodiments of the disclosure, using a binary electrical turbine system, which uses a heat exchanger to transfer heat from the combustion products produced from the ventilation production wells 30 to a secondary working fluid. The secondary working fluid may be water, for example, or it may be another low boiling point fluid such as propane or other suitable working fluids as would be known to a person skilled in the art. The combustion products may be separated using conventional gas separation technologies to recover any valuable gas components (such as hydrogen, methane, and other LPG products), condensate, oil that may be entrained, carbon oxide gases (CO₂, CO) and nitrogen. The valuable gas products may be sold as an unrefined stream or used on site for energy to run all the different processes and systems. The oil may be sold to market while the reservoir is heating, and eventually, the produced oil may be re-injected back into the formation for combustion through the oil re-injection horizontal wells 40, once there is stable production of electricity.

In some circumstances there may be some hindrances to the delivery of electricity to the grid, or in other circumstances the amount of electricity generation potential exceeds what could be delivered to the grid. This may be due to competition with other electricity producers to get electricity to market, leading to intermittent dispatch from CEFO, a lack of electrical substations or other infrastructure in the area at the time of construction and operation, or longer term maintenance issues with the electrical grid infrastructure. In such cases, it may be beneficial to install electrolyzer equipment so as to convert the electricity generated by CEFO to hydrogen by electrolysis. The process of electrolysis will convert water and electricity to produce oxygen and hydrogen. The hydrogen may be shipped to market by tanker trucks and the oxygen may be used to enrich the injected air stream to better improve the in-situ combustion process.

The waste by-products of combustion, such as the carbon oxide and nitrogen gases, may preferably be injected into another geologic formation for disposal, such as into a saline water bearing formation for permanent sequestration or into another oil reservoir for enhanced oil recovery and permanent sequestration; or any other disposal option for the carbon oxide gases as is known or will be known to a person skilled in the art.

Once there is stable generation of electricity, due to the high temperature of the closed loop circulating water and the high temperature of the ventilation production fluid, the produced oil would be collected and re-injected back into the formation to be combusted. This will lead to a pseudo-steady-state operation in which the walls of the combustion chamber, delineated by the combustion front 50, will retain the slopes that enhance gravity drainage of the oil down to the oxygen injection well 20, leading to improved mixing and combustion of the oxygen and hydrocarbons. Practitioners of the art will recognize what is meant by the term “pseudo-steady-state operations.”

Over time, the combusted oil will continue to deplete, even with the re-injection of produced oil. Eventually there will not be sufficient oil or gravity drainage to operate CEFO as a continuous flow process. In this case it may be desirable to explore a cyclic process, in which there is intermittent injection of the oxygen-rich stream and intermittent production from the ventilation production wells and may also include the reduction of the annualized average amount of oxygen injected into the reservoir. The closed loop water circulation wells 10 will operate continuously. These optimizations of continuous versus cyclic operations are part of any normal reservoir performance optimization and are intended to be included in the scope of the present disclosure.

The snapshot in time, when the combustion front 50 has expanded to encompass all of the lateral wells 106 of the MLTCS systems 10 and the ventilation production wells 30, is shown in FIGS. 3A and 3B. The fluid produced from the ventilation wells 30 is very hot at this stage, and the composition of the fluids will have high amounts of combustion products and thermally cracked products such as hydrogen, methane, LPG and low viscosity oil. The produced water will have much lower salinity than the original formation brine, since one of the combustion products is water that is free of any salts, and may be recovered for use in suitable applications, such as industrial use or agricultural irrigation.

Late Stage CEFO Operation: Wind Down and Recovery of Heat and Valuable Products to Improve Efficiency

At a very late stage in the process, the combustion of oil cannot be optimally continued. The combustion chambers from different air injection combustion chambers have begun to coalesce at the top of the formation and the slope of the combustion zone and oil saturation zone is less steep. At this late stage in the process, the CEFO process will then go into a project “wind down” phase in which the heat in the reservoir, along with valuable products such as hydrogen, methane, LPG, condensate and oil, will be recovered to maximize resource recovery and utilization. At the end of the CEFO process there is still an enormous amount of thermal energy in the rocks of the formation. The rocks of a typical formation will occupy from 65% to 80% of the bulk volume of the formation. In addition, the cap rock will also be very hot at the end of CEFO. The wind-down process is intended primarily to use the process of convective heat transfer to move the heat from the formation rock and the cap rock to the closed loop circulation wells. If the recovery of heat were to rely only on conductive heat transfer, the process timeline would be prolonged perhaps 10 to 20 times and the produced temperature will not be observed to increase during the wind down phase. Convective heat transfer is accomplished by injecting cold water, which will flash to steam when it contacts the high temperature formation and the steam will rise to the top of the formation and flow past the closed loop circulation wells. This effect is clearly observed in the increase in the temperature of the water in the closed loop circulation well system.

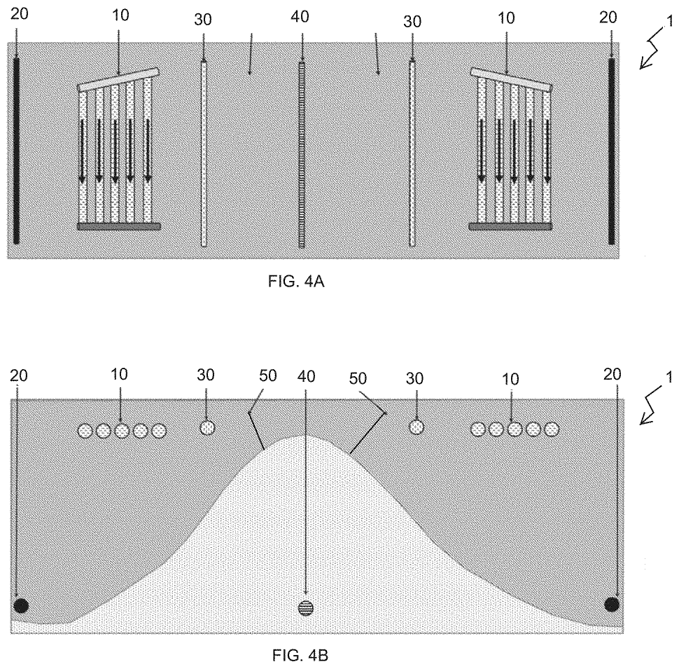

The start of the “wind down” phase is depicted in FIGS. 4A and 4B. In some embodiments, the wind down phase includes ceasing the injection of oxygen-rich air into the air injector well 20, and instead, converting the air injector wells 20 into water injection wells 20. The water will heat up in the formation as it contacts the very hot rock to form steam, and this steam will help to volatilize lighter hydrocarbon components, which will be produced from the ventilation production wells 30. In addition, the heat will be mobilized to the top of the formation and be captured by the MLTCS wells 10, which continue their operation as closed loop water circulation wells. The purpose of the project wind down phase is to continue to operate the process by reducing variable operating costs and increasing marginal profitability as long as possible, which will increase the overall efficiency of the CEFO process. The specific details of the wind down phase for any reservoir system will be engineered and designed for each unique reservoir, using techniques known to a person skilled in the art, and such variations are included in the scope of the present disclosure.

Additional Features, Illustrations and a Simulated Example of CEFO

Multilateral Thermal Capture System: Well Design Options

In the discussion that follows, it will be appreciated by a person skilled in the art that when referring to horizontal wells in the present specification, the terms “horizontal” and “parallel” are not intended to mean precisely horizontal or parallel in a strictly mathematical sense. Rather, it is appreciated that the drilling of horizontal wells through a geological formation will include normal drilling deviations in accordance with best industry practices. The resulting horizontal wells may not be precisely parallel to one another, but will be as close as reasonably possible to mathematically parallel, and horizontal relative to the surface above the geological formation, taking into account such normal drilling deviations. Thus, the use of the terms “parallel” and “substantially parallel”, as used in the present specification, refer to parallel horizontal wells that are as close as reasonably possible to being parallel, including normal drilling deviations in accordance with best industry practices.

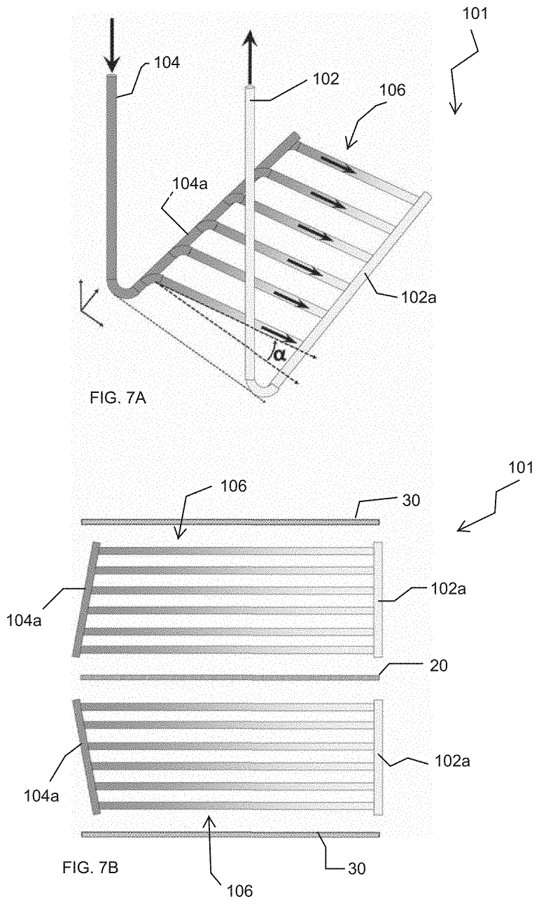

A fundamental part of the CEFO process is the use of closed loop water circulation wells to extract heat from the formation. There are many possible methods to drill and complete the MLTCS well systems 10. Several examples of embodiments are illustrated in FIGS. 6A to 9B. For the design of the system shown in FIGS. 6A and 6B there are two manifold wells 102a, 104a drilled into the formation as horizontal “trunk line” wells. One trunk line well 104a connects to the surface at the water injection wellhead through injection side riser well 104, and the other trunk line well 102a connects to the surface at the water production wellhead through production side riser well 102. From each horizontal trunk line 102a, 104a, a plurality of horizontal lateral wells 106 are drilled that will connect the production trunk line horizontal well 102a to the injection trunk line horizontal well 104a. There are various options to accomplish this task, and all options that are similar to the depictions in FIG. 5 are included in the present disclosure. As shown in FIG. 6A, the laterals are all substantially parallel to one other and drilled by kicking off each lateral well 105 from one trunk line 102a or 104a, at approximately 90 degrees, and drilling horizontally to intersect the second trunk line 102a or 104a at approximately 90 degrees. A slight variation on the embodiment shown in FIGS. 6A and 6B is depicted in FIGS. 7A and 7B, where the lateral wells 106 are all parallel to each other, but drilled off of the first trunk line well 104a at an angle a that is greater than 0° and less than approximately 15°, and then drilled horizontally to intersect the second horizontal trunk line well 102a. Such variations in drilling represent a balance between capital costs, resource utilization and drilling viability, as will be appreciated by a person skilled in the art, wherein the decision on which variation is to be used depends upon the drilling viability that is specific to each reservoir system.

An advantage of using the manifold wells in the drilling of the MLTCS is this design reduces the drilling risks, as the manifold well (also referred to as a trunkline well) provides a larger target for intersection by the plurality of lateral wells, and therefore does not require the same level of precision since the lateral intersection of each lateral horizontal well with the manifold well can be within several meters of the intended intersection target point at the manifold well, all of which will therefore reduce or eliminate the risk that the lateral horizontal wells will fail to intersect and connect to each other. Additionally, the shallow positioning of the MLTCS horizontal lateral wells is simpler to accomplish using industry standard drilling instrumentation and geo-steering techniques, at a typical depth of approximately 1-2 km beneath the surface where the drilling cone of uncertainty is small and the use of geosteering instrumentation will not fail since at these depths the formation temperature is low. At the depths intended for CEFO, the formation temperatures may be 100° C. or less, which temperatures pose no problem for the electrical components of geosteering and well logging devices, which are capable of operating up to 200° C. In contrast, in the process envisioned by Eavor, the depth would be over 7 km in, for example, Alberta, Canada, and the temperature at these depths could be 225° C. or higher, leading to failure of standard electronics. Furthermore, the multilateral well system proposed by Eavor does not utilize manifold wells, and is drilled at greater depths beneath the surface, such as 5 to 8 km depths, so as to reach the temperatures necessary for geothermal reservoirs to be able to harvest geothermal energy for electricity generation. Drilling horizontal multilateral wells at such depths is not conventional in the industry, and is both difficult and expensive to achieve using known drilling techniques and geo-steering instrumentation. For example, Eavor's pilot project in Alberta only drilled to a depth of 2.4 km from surface, and each lateral had a length of only 2 km.

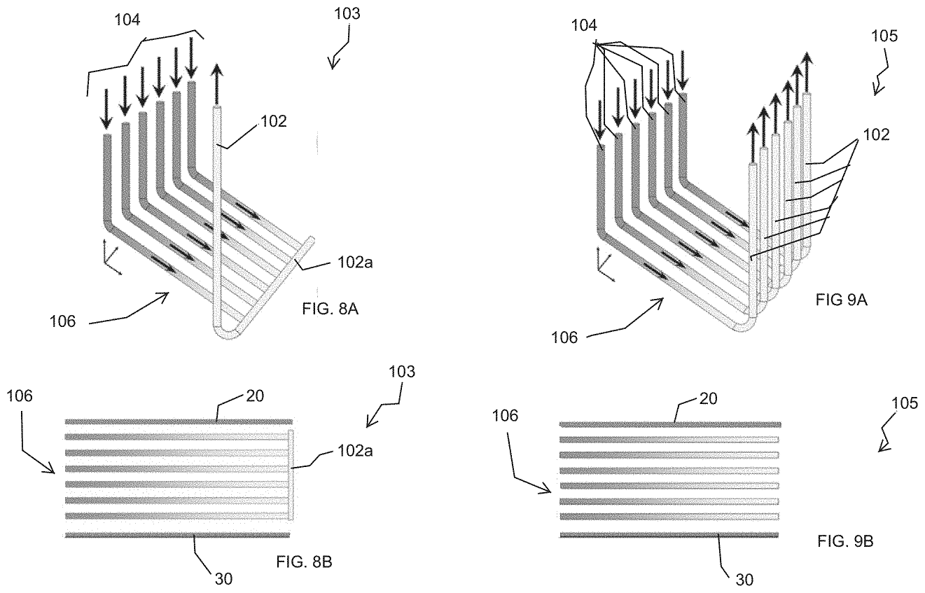

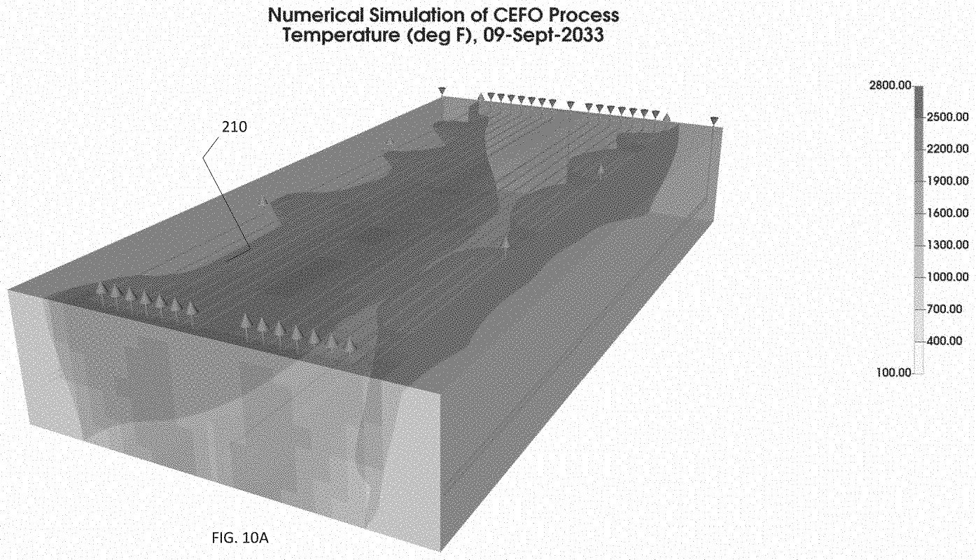

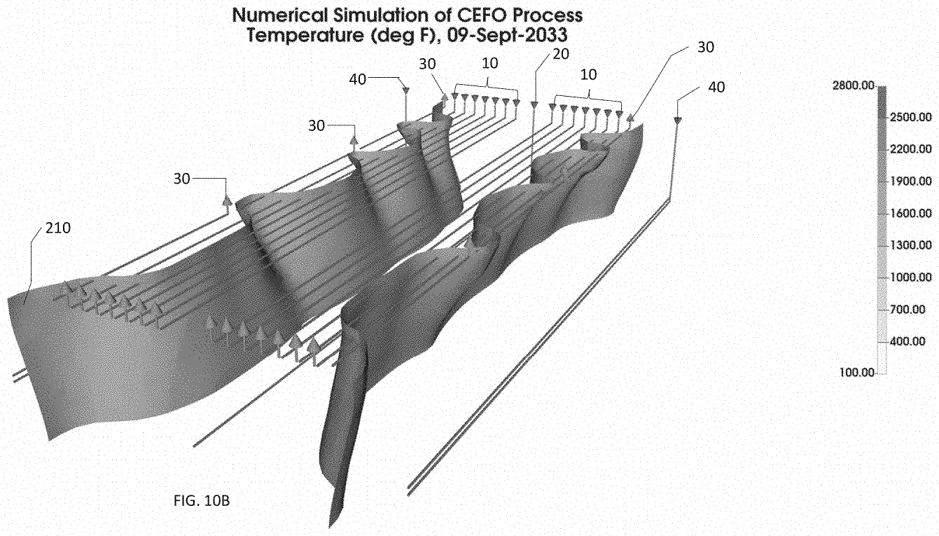

In other embodiments, there may be situations (such as very shallow formations for which the drilling cost of separate vertical risers will be very low) in which it is preferable to drill some of the lateral wells from the surface without the use of a downhole horizontal manifold well. Two such embodiments are shown in FIGS. 8A-8B and 9A-9B, respectively. In FIG. 8A, a single downhole horizontal manifold well 102a is drilled and is connected to the production wellhead via the production riser well 102. Each horizontal lateral well 106 is drilled from surface and each has its own injection wellhead, the injection wellheads connected to the horizontal lateral wells 106 via the plurality of injection riser wells 104. Embodiments also include reversing the arrangement in FIGS. 8A and 8B, such that the horizontal manifold is connected to a single injection wellhead via a single injection riser well 104 and each production horizontal lateral well has a separate production wellhead via a plurality of production riser wells 102 (not shown). However, such a case is less desirable as the heat losses from the many vertical production riser strings 102 will be higher than having one production riser string 102 that produces all the fluid from the downhole lateral wells.

It is also possible to drill every horizontal lateral well from surface on both the injection and production side, as shown in FIGS. 9A and 9B. In this case, there are no downhole manifold horizontal wells 102a or 104a. It will be appreciated that there are many other variations of the horizontal thermal capture system that may be designed and implemented, including combinations of any of the embodiments depicted in FIGS. 5A through 9B, and that such horizontal thermal capture systems are intended to be included in the scope of the present disclosure.

Simulated Example of the CEFO Process

The CEFO process has been extensively modeled using the commercial petroleum reservoir simulation platform from Computer Modeling Group™. The main program for solving the mathematical model is STARS™, a long-established commercial petroleum reservoir simulator that includes the mathematical formulation for mass, momentum and energy balances along with chemical reactions and advance wellbore modeling capability. The STARS™ program performs comprehensive material and energy balance calculations, along with phase partitioning of the molecular components between the oil, gas and water phases and multiphase chemical reaction mechanisms.

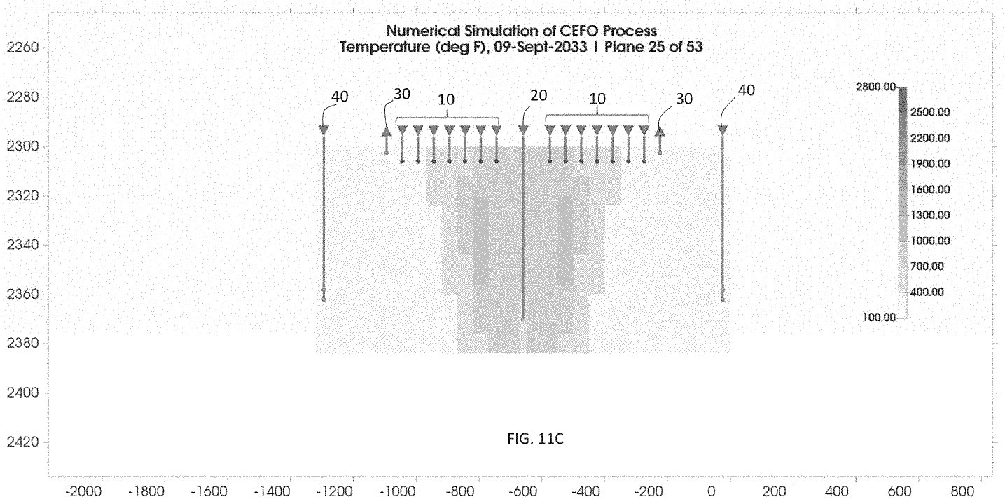

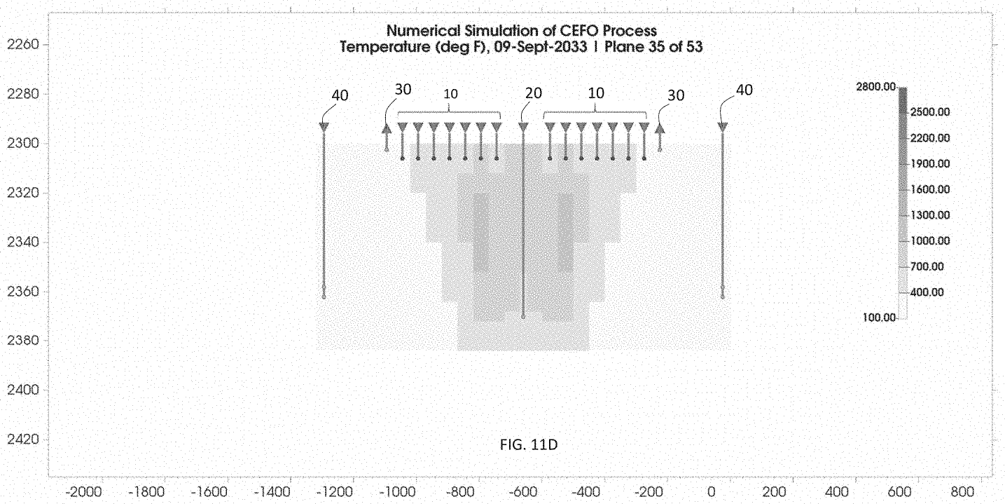

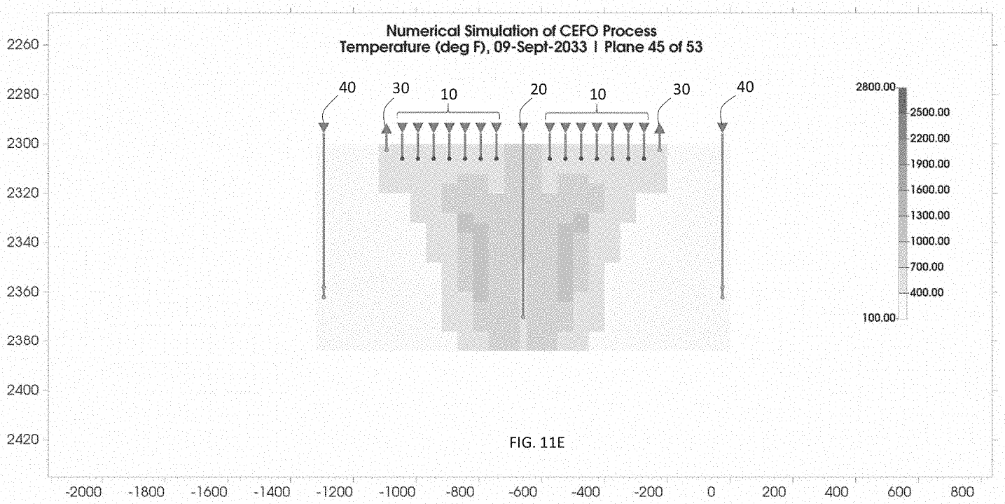

The reservoir system used to model CEFO represents a three-dimensional construct that is typical of many heavy oil bearing reservoirs in terms of the rock properties and fluid properties. The model encompasses 80 acres of land or ⅛ of a section of land (1 square mile, or 640 acres, or 258.8 hectares). The reservoir horizontal permeability varies from 550 mD at the base of the formation to 1800 mD at the top of the formation. The ratio of vertical to horizontal permeability is 0.1. The porosity varies from 21.6% at the base to 24.7% at the top of the formation. The initial temperature of the formation is 100° F. and the initial pressure is 2250 psi. The initial oil viscosity is 504 cP and there is no initial free gas phase. The initial water saturation is 20%. The thickness of the formation is 84 feet. Persons skilled in the art will know what is meant by this system of units for the physical properties. The dimensions of each grid cell, shown in FIGS. 10A to 11E, are approximately 50 ft×50 ft×4 ft, which is a resolution that is typical for the numeric modeling of thermal processes in an oil reservoir. The MLTCS wells are designed to have no mass transfer to the formation; only heat transfer is allowed.

The initial phase of the reservoir operation is a waterflood, which is typical for heavy oils. The watercut rapidly rises due to instability of the low viscosity of the water compared to the high viscosity oil and reaches the typical economic limit of over 95% by around simulation day 3000.

The images shown in FIGS. 10A to 11E represent output from the simulation model for the temperature distribution in the formation after 2000 days of CEFO operation. In FIGS. 10B and 10C, the sloping surfaces show the temperature front 210 where the temperature in the formation is 400° F. The front 210 shows undulations that reflect to some extent the natural variability in the location of the combustion front as it expands through the reservoir as the process progresses.

FIG. 10C shows the location of five slices and the two-dimensional temperature distribution for each slice. The slices are normal to the direction of the horizontal wells, spaced apart by one another by 500 feet. More details on the temperature distribution for these five slices are provided in FIGS. 11A to 11E, showing a two-dimensional representation of each slice.

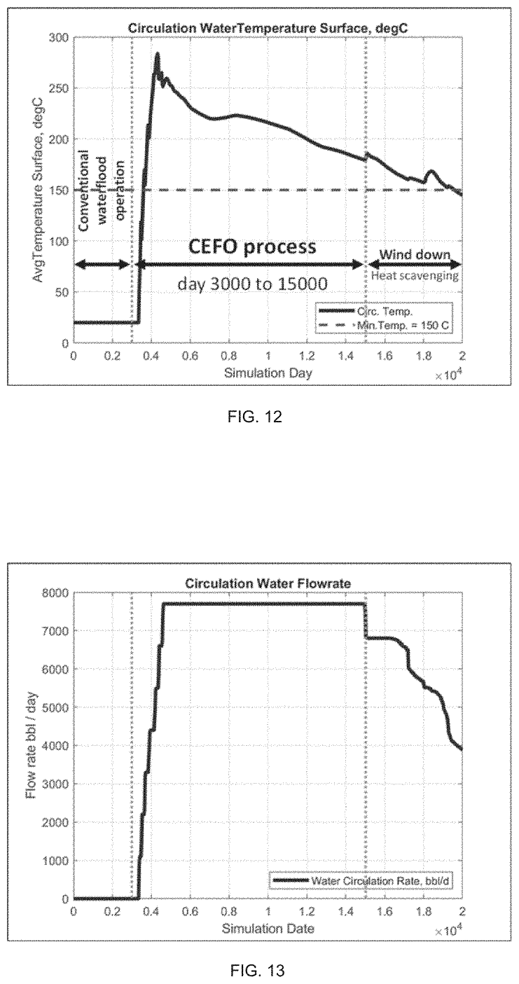

FIG. 12 provides the surface temperature of the circulating water at the production wellhead over time. The minimally accepted temperature to generate electricity using a flash steam turbine system is 150° C. The CEFO process commences at simulation day 3,000 and runs until simulation day 15,000 after which the process begins a slow “wind down” phase to recover extra heat from the formation. This can be observed by the increase in the temperature of the circulated water after day 15,000. It is observed that there is more than sufficient temperature to drive a flash steam turbine system from approximately day 3,400 to about day 19,500.

FIG. 13 provides the water flow rate through the closed loop MLTCS system. This is an 80 acre sector model, so a full section of land will produce eight times as much hot water. The actual size of a reservoir for real world applications would be at least 320 acres (130 hectare). In the depicted embodiment, the flow rate is adjusted to keep the produced water temperature above 150° C. as long as possible.

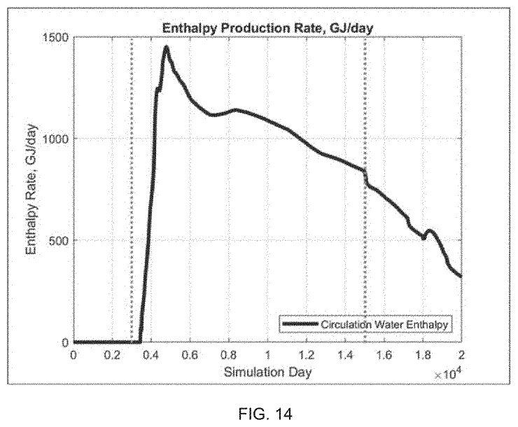

FIG. 14 provides the enthalpy production rate of the water in the MLTCS closed loop system. This is for an 80 acre sector model, so for one section of land, this enthalpy profile would be multiplied by a factor of eight.

The design of the well system depicted in FIGS. 10A to 11E for the for the reservoir system modelled (rock properties and fluid properties) is optimized for that particular reservoir system. For different reservoir systems having different properties, the optimization process would be repeated, leading to different profiles than those shown in the graphs of FIGS. 12 to 14. Such adaptations of the CEFO process to different reservoir systems are included in the present disclosure.

What is claimed is:

1. A process for producing dean energy from oil bearing reservoirs, the process comprising the steps of:
utilizing in-situ combustion to combust oil within an oil-bearing formation so as to generate thermal energy;
producing the generated thermal energy to a surface using a closed loop well system, the closed loop well system comprising a plurality of horizontal lateral circulation wells to circulate a working fluid between the ground-level surface and the subterranean oil-bearing formation so as to capture the generated thermal energy in the oil-bearing formation and transfer the captured generated thermal energy to the surface;
producing a plurality of combustion products to the surface using a plurality of production wells.

2. The process of claim 1, wherein the generated thermal energy captured in the working fluid is flashed at surface to a lower pressure thereby converting the working fluid from a liquid-phase to a high pressure vapour-phase, and wherein the high pressure vapour-phase then flows through a steam turbine system to generate electricity.

3. The process of claim 1, wherein the generated thermal energy captured in the working fluid is utilized for a heating application selected from the group comprising: district heating, greenhouse agriculture.

4. The process of claim 1, wherein the plurality of combustion products includes gaseous combustion products, and wherein the generated thermal energy captured in the gaseous production products is transferred to a secondary working fluid so as to generate a secondary high pressure vapour-phase, and wherein the secondary high pressure vapour-phase then flows through the steam turbine system to generate electricity.

5. The process of claim 2, wherein the working fluid has a boiling point equal to or lower than water.

6. The process of claim 4, wherein the working fluid and the secondary working fluid each have a boiling point equal to or lower than water.

7. The process of claim 1, wherein each horizontal lateral circulation well of the plurality of horizontal lateral circulation wells is substantially parallel to one another.

8. The process of claim 1, wherein the plurality of horizontal lateral circulation wells are in fluid communication with one another through at least one horizontal manifold well, the horizontal manifold well intersecting the plurality of horizontal lateral wells.

9. The process of claim 1, wherein the plurality of horizontal lateral circulation wells includes two or more sets of horizontal lateral circulation wells, wherein the two or more sets of horizontal lateral circulation wells are positioned laterally of and substantially parallel to at least one horizontal air injection well.

10. The process of claim 9, wherein the at least one horizontal air injection well is positioned at an air injection depth in the oil-bearing formation and each set of the two or more sets of horizontal lateral circulation wells are positioned at a circulation well depth in the oil-bearing formation, and wherein the air injection depth from ground level exceeds the circulation well depth from ground level.

11. The process of claim 1, wherein the plurality of combustion products includes valuable by-product gases and waste by-product gases, the process further comprising the steps of: separating and recovering the valuable by-product gases at the surface and separating and injecting the waste by-product gases into a second oil-bearing formation for permanent storage.

12. The process of claim 9, wherein when a volume of produced valuable by-product gases is under a selected threshold, the process further includes the step of injecting the valuable by-product gases into a second oil-bearing formation for temporary storage.

13. The process of claim 11, wherein the waste by-product gases includes CO₂ and wherein the step of injecting the waste by-product gases into a second oil-bearing formation, wherein the said CO₂ in the waste by-product gases improves oil recovery from the second oil-bearing formation and permanently stores the said CO₂ in the second oil-bearing formation by a process selected from the group comprising: CO₂ miscible enhanced oil recovery process, CO₂ immiscible enhanced oil recovery process.

14. The process of claim 11, wherein the valuable by-product gases are selected from a group comprising: hydrogen, methane, liquified petroleum gases, condensate, oil.

15. The process of claim 11, wherein the valuable by-product gases that are produced to the surface are used as a supplemental source of energy to power on-site systems.

16. The process of claim 11, wherein the valuable by-product gases recovered at the surface are re-injected into the oil-bearing formation as an input into the in-situ combustion so as to generate the thermal energy within the oil-bearing formation.

17. The process of claim 11, wherein the valuable by-product gases are re-injected into the oil-bearing formation as an input to the in-situ combustion for generating thermal energy in the oil-bearing formation, and wherein the waste by-product gases are injected into a second oil-bearing formation for permanent storage so as to release a net volume of zero by-product gases into an atmosphere.

18. The process of claim 1, further comprising the step of pre-heating the oil-bearing formation to a temperature threshold that enables auto-ignition of the oil when oxygen is injected into the oil-bearing formation so as to form a combustion chamber in the oil-bearing formation.

19. The process of claim 16, wherein the process further includes the step of recovering a portion of oil from the oil-bearing formation and wherein, when the combustion chamber has reached a selected temperature, the portion of oil recovered from the oil-bearing formation is re-injected into the oil-bearing formation as an input into the in-situ combustion so as to generate the thermal energy within the oil-bearing formation.

20. The process of claim 2 further comprising the steps of: applying the electricity generated from the steam turbine system to an electrolysis plant so as to generate hydrogen and oxygen from water; shipping the generated hydrogen for off-site energy use; adding the generated oxygen to an injection stream of the in-situ combustion so as to generate thermal energy in the oil-bearing formation.

21. The process of claim 2 wherein the electricity generated from the steam turbine system transferred to an electrical grid.

22. The process of claim 1 wherein, when the process reaches a sate maturity stage, the step of utilizing in-situ combustion is halted and the generated thermal energy in the oil reservoir continues to be produced to the surface using the closed loop well system during a wind-down period so as to increase the overall thermal efficiency of the process.

23. The process of claim 1, wherein the step of utilizing in-situ combustion is cyclically controlled so as to maintain an amount of generated thermal energy in the oil reservoir within a targeted range.

24. The process of claim 1, wherein the oil reservoir is selected from a group comprising: medium oil reservoir, heavy oil reservoir, bitumen oil reservoir.

25. A system for producing clean energy from oil bearing reservoirs, the system comprising:
an air injection well for injecting oxygen-enriched air into a subterranean oil reservoir for in-situ combustion of oil contained therein so as to generate thermal energy;
a closed loop well system comprising at least two sets of a plurality of horizontal lateral circulation wells to circulate a working fluid between the oil reservoir and a ground-level surface above the oil reservoir so as to capture the generated thermal energy and transfer the captured generated thermal energy to the surface;
a production ventilation well for producing combustion by-products of the in-situ combustion to the surface; and
a steam turbine system driven by the circulating working fluid so as to generate electricity.

26. The system of claim 25 further comprising an oil injection well, wherein oil produced through the production ventilation well is re-injected into the oil reservoir as an input to the in-situ combustion.

27. The system of claim 25, further comprising a secondary heat exchanger containing a secondary working fluid, the secondary heat exchanger in thermal communication the production ventilation well so as to capture thermal energy from the combustion by-products produced through the production ventilation well, and wherein the secondary working fluid is used as an input to the steam turbine system.

28. The system of claim 25, further comprising an electrolysis plant, the electrolysis plant driven by the electricity generated by the steam turbine system, wherein the electrolysis plant electrolyzes water so as to generate hydrogen and oxygen, and wherein the generated hydrogen is shipped off site for energy use, and the generated oxygen is used as an input to the in-situ combustion of the oil in the oil-bearing formation so as to generate the thermal energy.
